(19) United States
(12) Patent Application Publication
(10) Pub. No.: US 2025/0024443 A1
(43) Pub. Date: Jan. 16, 2025

(54) FIRST WIRELESS COMMUNICATION DEVICE AND SECOND WIRELESS COMMUNICATION DEVICE

(71) Applicant: FUJITSU LIMITED, Kawasaki-shi (JP)

(72) Inventors: Yoshiaki OHTA, Yokohama (JP); YOSHIHIRO KAWASAKI, Kawasaki (JP); Tetsuya YANO, Yokohama (JP)

(73) Assignee: FUJITSU LIMITED, Kawasaki-shi (JP)

(21) Appl. No.: 18/884,257

(22) Filed: Sep. 13, 2024

Related U.S. Application Data
(63) Continuation of application No. PCT/JP2022/013318, filed on Mar. 22, 2022.

(51) Int. Cl. H04W 72/0453; H04W 72/23

(52) U.S. Cl. CPC H04W 72/0453; H04W 72/23

(57) ABSTRACT

A first wireless communication device that performs pre-allocated communication to communicate with a second wireless communication device, using a radio resource that is configured beforehand, the first wireless communication device includes a controller configured to reconfigure a frequency of a pre-allocated radio resource in the second wireless communication device while maintaining a preconfigured transmission cycle of the pre-allocated radio resource, and control implementation of the pre-allocated communication that uses the reconfigured frequency of the pre-allocated radio resource.

### CROSS-REFERENCE TO RELATED APPLICATION

This application is a continuation application of International Application PCT/JP2022/013318 filed on Mar. 22, 2022 and designated the U.S., the entire contents of which are incorporated herein by reference.

### FIELD

The embodiments discussed herein are related to a first wireless communication device and a second wireless communication device.

### BACKGROUND

Wireless communication systems using wireless technologies are used these days. Wireless communication systems are used in facilities such as factories, for example.

In a factory, manufacturing equipment and devices are wirelessly connected to a controlled monitoring system, and data and control signals are transmitted and received using Internet of Things (IoT), for example. The IoT used in factories is referred to as Industrial IoT (IIoT) in some cases, for example.

In IIoT, for example, the terminal device side configures a network, and the GW (UE-GW) on the terminal device side is responsible for communication in some cases. Traffic (data) in a terminal device is periodically (as planned) generated (periodic deterministic traffic (PDT)), for example. The traffic is transmitted on a radio resource of a configured grant (CG) (hereinafter referred to as a CG resource in some cases) in uplink wireless transmission, and on semi-persistent scheduling (SPS) in downlink wireless transmission, for example.

Technologies related to IIoT are described in the following related art documents.

3GPP TS36.133 LTE-A Radio Measurement Specification, 3GPP TS36.300 LTE-A General Specification, 3GPP TS36.211 LTE-A PHY Channel Specification, 3GPP TS36.212 LTE-A PHY Coding Specification, 3GPP TS36.213 LTE-A PHY Procedure Specification, 3GPP TS36.214 LTE-A PHY Measurement Specification, 3GPP TS36.321 LTE-A MAC Specification, 3GPP TS36.322 LTE-A RLC Specification, 3GPP TS36.323 LTE-A PDCP Specification, 3GPP TS36.331 LTE-A RRC Specification, 3GPP TS36.413 LTE-A S1 Specification, 3GPP TS36.423 LTE-A X2 Specification, 3GPP TS36.425 LTE-A Xn Specification, 3GPP TR36.912 NR Radio Access Overview, 3GPP TR38.913 NR Requirements, 3GPP TR38.801 NR Network Architecture Overview, 3GPP TR38.802 NR PHY Overview, 3GPP TR38.803 NR RF Overview, 3GPP TR38.804 NR L2 Overview, 3GPP TR38.900 NR High Frequency Overview, 3GPP TS38.300 NR General Specification, 3GPP TS37.340 NR Multi-Connectivity General Specification, 3GPP TS38.201 NR PHY Specification General Specification, 3GPP TS38.202 NR PHY Service General Specification, 3GPP TS38.211 NR PHY Channel Specification, 3GPP TS38.212 NR PHY Coding Specification, 3GPP TS38.213 NR PHY Data Channel Procedure Specification, 3GPP TS38.214 NR PHY Control Channel Procedure Specification, 3GPP TS38.215 NR PHY Measurement Specification, 3GPP TS38.321 NR MAC Specification, 3GPP TS38.322 NR RLC Specification, 3GPP TS38.323 NR PDCP Specification, 3GPP TS37.324 NR SDAP Specification, 3GPP TS38.331 NR RRC Specification, 3GPP TS38.401 NR Architecture General Specification, 3GPP TS38.410 NR Core Network General Specification, 3GPP TS38.413 NR Core Network AP Specification, 3GPP TS38.420 NR Xn Interface General Specification, 3GPP TS38.423 NR XnAP Specification, 3GPP TS38.470 NR F1 Interface General Specification, and 3GPP TS38.473 NR F1AP Specification are disclosed as related art.

### SUMMARY

According to an aspect of the embodiments, a first wireless communication device that performs pre-allocated communication to communicate with a second wireless communication device, using a radio resource that is configured beforehand, the first wireless communication device includes a controller configured to reconfigure a frequency of a pre-allocated radio resource in the second wireless communication device while maintaining a preconfigured transmission cycle of the pre-allocated radio resource, and control implementation of the pre-allocated communication that uses the reconfigured frequency of the pre-allocated radio resource.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIGS. 1A and 1B are diagrams illustrating an example of wireless communication in a wireless communication system 3;

FIG. 2 is a diagram illustrating an example configuration of a wireless communication system 10;

FIG. 3 is a diagram illustrating an example configuration of a terminal device 100;

FIG. 4 is a diagram illustrating an example configuration of a base station device 200;

FIGS. 5A and 5B are tables illustrating examples of PDCCHs in the case of a single configuration;

FIGS. 6A and 6B are tables illustrating examples of PDCCHs in the case of a multiple configuration;

FIGS. 7A and 7B are tables illustrating examples of PDCCHs in the case of a single configuration;

FIGS. 8A and 8B are tables illustrating examples of PDCCHs in the case of a multiple configuration;

FIG. 9 is a diagram illustrating an example of radio resources in a use case 1;

FIG. 10 is a diagram illustrating an example of radio resources in the use case 1;

FIG. 11 is a diagram illustrating an example of radio resources in a use case 2; and

FIG. 12 is a diagram illustrating an example of radio resources in the use case 2.

### DESCRIPTION OF EMBODIMENTS

There are cases where a terminal device is to change the frequency of a CG resource, depending on a change in the radio condition or the like, for example. On the other hand, there are cases where a terminal device is to maintain the transmission cycle of the CG resource, regardless of whether there is a change in the frequency of the CG resource. However, when the frequency of the CG resource is changed, the terminal device might not be able to maintain the transmission cycle of the CG resource.

Therefore, the embodiments discussed herein provide a first wireless communication device and a second wireless communication device capable of flexibly changing the frequency of a CG resource.

### First Embodiment

A first embodiment is now described.

A wireless communication system 3 is a wireless communication system that includes a first wireless communication device 1 and a second wireless communication device 2. The first wireless communication device 1 and the second wireless communication device 2 wirelessly perform communication. In the wireless communication system 3, the first wireless communication device 1 and the second wireless communication device 2 perform pre-allocated communication by transmitting and receiving data using a radio resource that has been configured in advance.

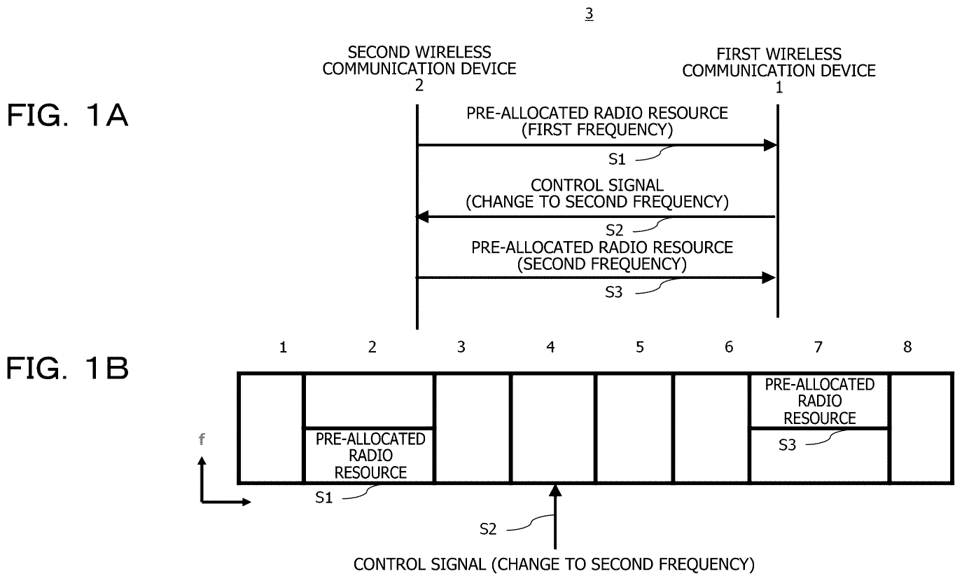

FIGS. 1A and 1B are diagrams illustrating an example of wireless communication in the wireless communication system 3. FIG. 1A is a diagram illustrating an example of a sequence in which data is transmitted from the second wireless communication device 2 to the first wireless communication device 1.

The second wireless communication device 2 transmits data to the first wireless communication device 1, using a radio resource that has been allocated beforehand (hereinafter referred to as a pre-allocated radio resource in some cases) (S1). The frequency of the pre-allocated radio resource is a first frequency.

The first wireless communication device 1 then transmits a control signal to the second wireless communication device 2 (S2). The control signal is a message indicating an instruction to change the frequency of the pre-allocated radio resource to be used by the second wireless communication device 2. The control signal includes information indicating that the frequency of the pre-allocated radio resource is to be changed to a second frequency.

When the transmission cycle of the pre-allocated radio resource comes, the second wireless communication device 2 transmits data to the first wireless communication device 1, using the pre-allocated radio resource of the second frequency (S3).

FIG. 1B is a diagram illustrating an example of radio resources. In FIG. 1B, the horizontal axis of the radio resources indicates time (transmission timing). The second wireless communication device 2 transmits data, using the pre-allocated radio resource of the first frequency in slot 2 (S1).

The second wireless communication device 2 then transmits a control signal from the first wireless communication device 1 (S2). The control signal includes information indicating that the frequency of the pre-allocated radio resource is to be changed to a second frequency.

When the transmission cycle of the pre-allocated radio resource (slot 7) comes, the second wireless communication device 2 then transmits data to the first wireless communication device 1, using the pre-allocated radio resource of the second frequency (S3).

In the first embodiment, the frequency of a pre-allocated radio resource is changed with a control signal, so that the frequency can be changed while the transmission cycle of the pre-allocated radio resources is maintained (without a change in the transmission timing).

### Second Embodiment

A second embodiment is now described.

### <Wireless Communication System 10>

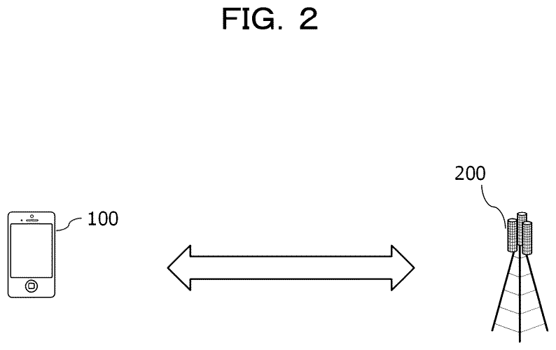

FIG. 2 is a diagram illustrating an example configuration of a wireless communication system 10. The wireless communication system 10 includes a base station device 200 and a terminal device 100. The wireless communication system 10 is a wireless communication system that is installed in a system and is compatible with HOT, for example.

The terminal device 100 is a communication device attached to equipment (a device) in the system. The base station device 200 is a communication device installed in the system.

For example, the base station device 200 is compatible with various generations of communication (such as 5G or Beyond 5G, for example). Further, the base station device 200 may be formed with one device, or may be formed with a plurality of devices such as a central unit (CU) and a distributed unit (DU).

The terminal device 100 periodically transmits data to the base station device 200, for example. The terminal device 100 uses radio resources of CG in the periodic (PDT) data transmission. Also, the terminal device 100 is also compatible with aperiodic (ADT) data transmission. The aperiodic data transmission includes data transmission that occurs with a delay from the periodic data transmission timing, for example. Furthermore, the terminal device 100 is compatible with a change in the frequency of a CG resource.

Note that there is one terminal device 100 in FIG. 2, but there may be a plurality of terminal devices. Further, in the following embodiments, data transmission from the terminal device 100 to the base station device 200 will be described as an example. However, similar processing can also be applied to communication between the terminal devices 100, and data transmission from the base station device 200 to the terminal devices 100.

### <Example Configuration of a Terminal Device 100>

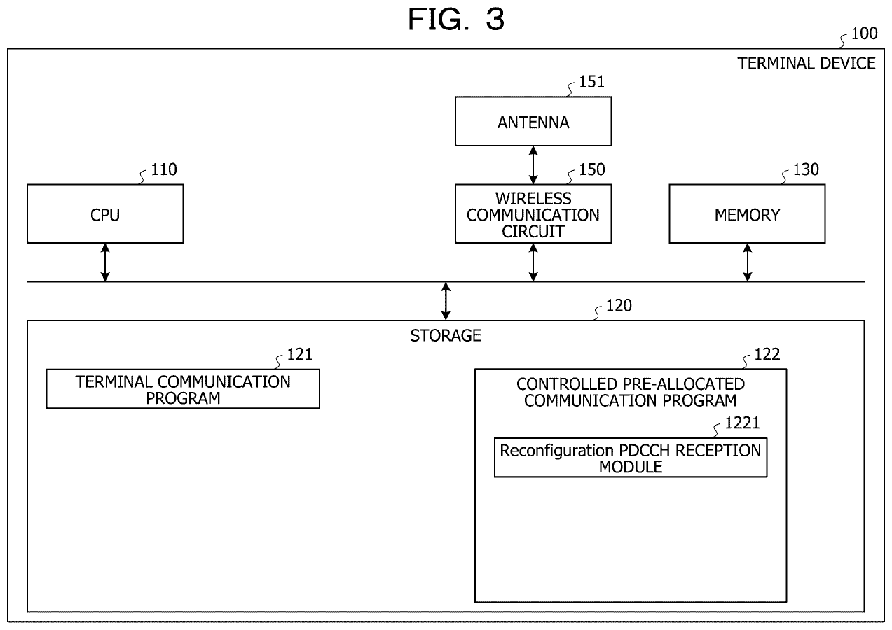

FIG. 3 is a diagram illustrating an example configuration of a terminal device 100. The terminal device 100 includes a central processing unit (CPU) 110, a storage 120, a memory 130, a wireless communication circuit 150, and an antenna 151.

The storage 120 is an auxiliary storage device that stores programs and data, such as a flash memory, a hard disk drive (HDD), or a solid state drive (SSD). The storage 120 stores a terminal communication program 121 and a controlled pre-allocated communication program 122.

The memory 130 is an area into which a program stored in the storage 120 is loaded. Also, the memory 130 may be used as an area into which a program stores data.

The wireless communication circuit 150 is a device that performs wireless communication with the base station device 200 and other terminal devices 100. The wireless communication circuit 150 has the antenna 151. The antenna 151 includes a directional antenna capable of controlling directions of transmission and reception of radio waves, for example.

The CPU 110 is a processor that loads a program stored in the storage 120 into the memory 130, and executes the loaded program, to build each component and implement each process.

By executing the terminal communication program 121, the CPU 110 constructs a second communication unit, and performs a terminal communication process. The terminal communication process is a process of performing wireless communication with the base station device 200 or another terminal device 100.

By executing the controlled pre-allocated communication program 122, the CPU 110 constructs the second control unit, and performs a controlled pre-allocated communication process. The controlled pre-allocated communication process is a process of controlling controlled pre-allocated communication by the terminal device 100 in accordance with an instruction from the base station device 200. In the controlled pre-allocated communication process, the terminal device 100 changes the frequency of a CG resource, for example. The terminal device 100 is instructed from the base station device 200 to change the frequency of the CG resource, and changes the frequency in accordance with the instruction.

By executing a reconfiguration PDCCH reception module 1221 included in the controlled pre-allocated communication program 122, the terminal device 100 constructs the second control unit, and performs a reconfiguration PDCCH reception process. The reconfiguration PDCCH reception process is a process of receiving a reconfiguration PDCCH and changing the frequency of a CG resource. The reconfiguration PDCCH will be described later.

### <Example Configuration of the Base Station Device 200>

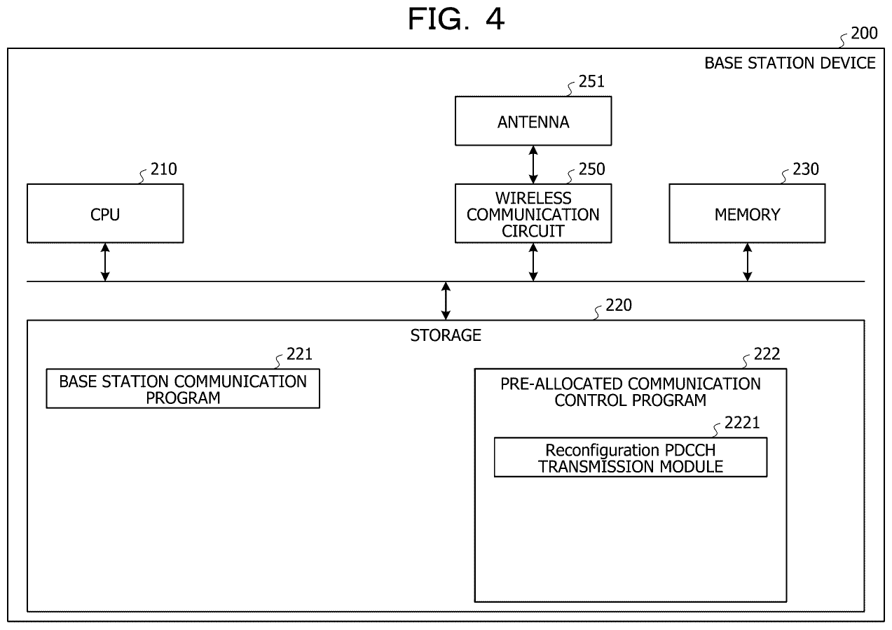

FIG. 4 is a diagram representing an example configuration of the base station device 200. The base station device 200 includes a CPU 210, a storage 220, a memory 230, a wireless communication circuit 250, and an antenna 251.

The storage 220 is an auxiliary storage device that stores programs and data, such as a flash memory, an HDD, or an SSD. The storage 220 stores a base station communication program 221 and a pre-allocated communication control program 222.

The memory 230 is an area into which a program stored in the storage 220 is loaded. Also, the memory 230 may be used as an area into which a program stores data.

The wireless communication circuit 250 is a device that performs wireless communication with a terminal device 100. The wireless communication circuit 250 has the antenna 251. The antenna 251 includes a directional antenna capable of controlling directions of transmission and reception of radio waves, for example.

The CPU 210 is a processor that loads a program stored in the storage 220 into the memory 230, and executes the loaded program, to build each component and implement each process.

By executing the base station communication program 221, the CPU 210 constructs a communication unit, and performs a communication process. The base station communication process is a process of performing wireless communication with a terminal device 100. In the base station communication process, the base station device 200 is wirelessly connected to the terminal device 100, transmits data and a control signal to the terminal device 100, and receives data from the terminal device 100.

By executing a reconfiguration PDCCH transmission module 2221 included in the pre-allocated communication control program 222, the CPU 210 constructs the control unit, and performs a reconfiguration PDCCH transmission process. The reconfiguration PDCCH transmission process is a process of transmitting a reconfiguration PDCCH including the changed frequency, when changing the frequency of a CG resource of the terminal device 100.

### <Frequency and Transmission Cycle of CG Resources>

The start of a transmission cycle of a CG resource is now described. There are the following three schemes for CG resource transmission cycles, for example.
CG type 1: The frequency and the transmission cycle are configured by RRC. A terminal device 100 starts a transmission cycle from the slot in which the RRC has been received.
CG type 2: Only the transmission cycle is configured by RRC. The terminal device 100 starts a transmission cycle from the slot in which an activation physical downlink control channel (PDCCH) for configuring a frequency has been received. On the other hand, when receiving a deactivation PDCCH, the terminal device 100 stops communication.
SPS: The frequency and the transmission cycle are configured by RRC. The terminal device 100 starts a transmission cycle from the slot in which an activation PDCCH has been received in a state in which the configuration is received by the RRC. On the other hand, when receiving a deactivation PDCCH, the terminal device 100 stops communication. Further, in each scheme, the transmission cycle is reconfigured as follows.
CG type 1: The terminal device 100 resumes the transmission cycle from the slot in which the RRC has been received.
CG type 2: The terminal device 100 resumes the transmission cycle from the slot in which the reactivation PDCCH has been received.
SPS: The terminal device 100 resumes the transmission cycle from the slot in which the reactivation PDCCH has been received.

In a scheme for changing the frequency and the transmission cycle using RRC and a reactivation PDCCH (including an activation PDCCH, which also applies hereinafter), the terminal device 100 might not be able to flexibly change the frequency and change (or maintain) the transmission cycle in some cases. Therefore, the wireless communication system 10 is made to be able to use a reconfiguration PDCCH.

### <Reconfiguration PDCCH>

In the description below, an example of four patterns of reconfiguration PDCCHs are explained. A Reconfiguration PDCCH is an example of a control signal (a reconfiguring control signal) for changing (reconfiguring) the frequency of a CG resource.

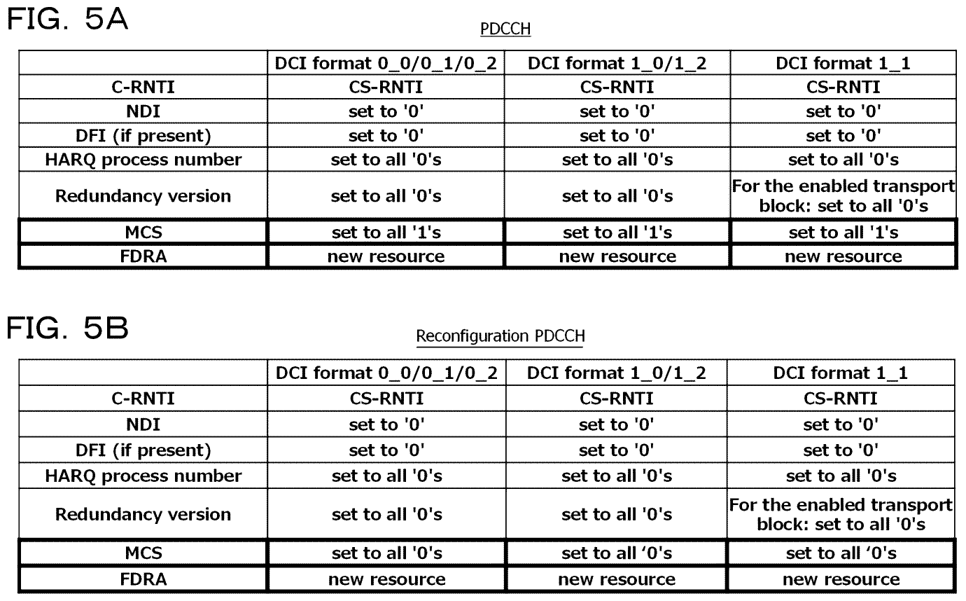

FIGS. 5A and 5B are tables illustrating examples of PDCCHs in the case of a single configuration. FIG. 5A illustrates a regular PDCCH, and FIG. 5B illustrates a reconfiguration PDCCH. Note that the regular PDCCH indicates a PDCCH that is not a reconfiguration PDCCH. Further, FIGS. 5A and 5B illustrate examples of information elements (fields) of PDCCHs.

In the Reconfiguration PDCCH, 0 is configured in Modulation and Coding Scheme (MCS). The MCS indicates a combination of a modulation scheme and a coding scheme. In a case where configured scheduling (CS)-RNTI is adopted, and NDI=0, has MCS is a value not to be used (a meaningless value), and accordingly, 0 may be configured in the MCS.

In the Reconfiguration PDCCH, the frequency of the CG resource to be changed is configured in Frequency Domain Resource Allocation (FDRA). The terminal device 100 changes the frequency of the subsequent CG resources to the frequency configured in the FDRA.

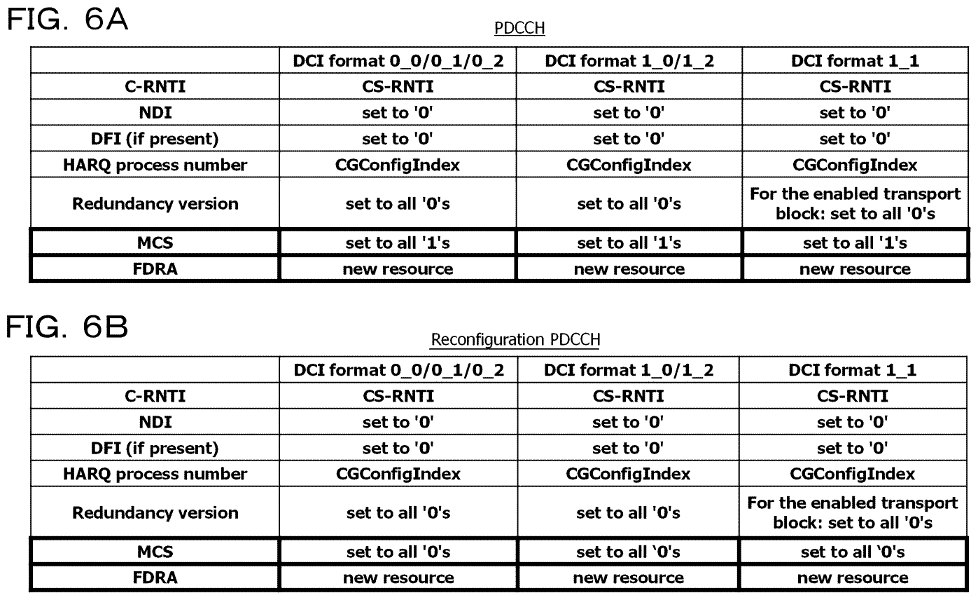

FIGS. 6A and 6B are tables illustrating examples of PDCCHs in the case of a multiple configuration. FIG. 6A illustrates a regular PDCCH, and FIG. 6B illustrates a reconfiguration PDCCH.

In the reconfiguration PDCCH, 0 is configured in the MCS.

In the reconfiguration PDCCH, the frequency of the CG resource to be changed is configured in the FDRA. The terminal device 100 changes the frequency of the subsequent CG resources to the frequency configured in the FDRA.

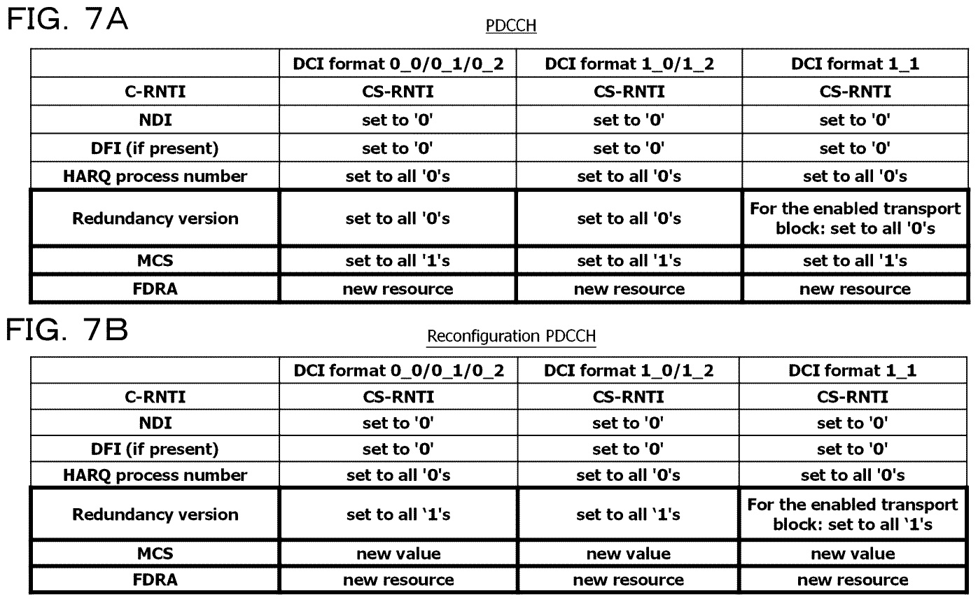

FIGS. 7A and 7B are tables illustrating examples of PDCCHs in the case of a single configuration. FIG. 7A illustrates a regular PDCCH, and FIG. 7B illustrates a reconfiguration PDCCH.

In the reconfiguration PDCCH, all “1”s is configured in the redundancy version. Inverting the redundancy version of a CG resource to all “1”s is defined in the specification.

In the reconfiguration PDCCH, a new MCS value is configured in the MCS.

In the reconfiguration PDCCH, the frequency of the CG resource to be changed is configured in the FDRA. The terminal device 100 changes the frequency of the subsequent CG resources to the frequency configured in the FDRA.

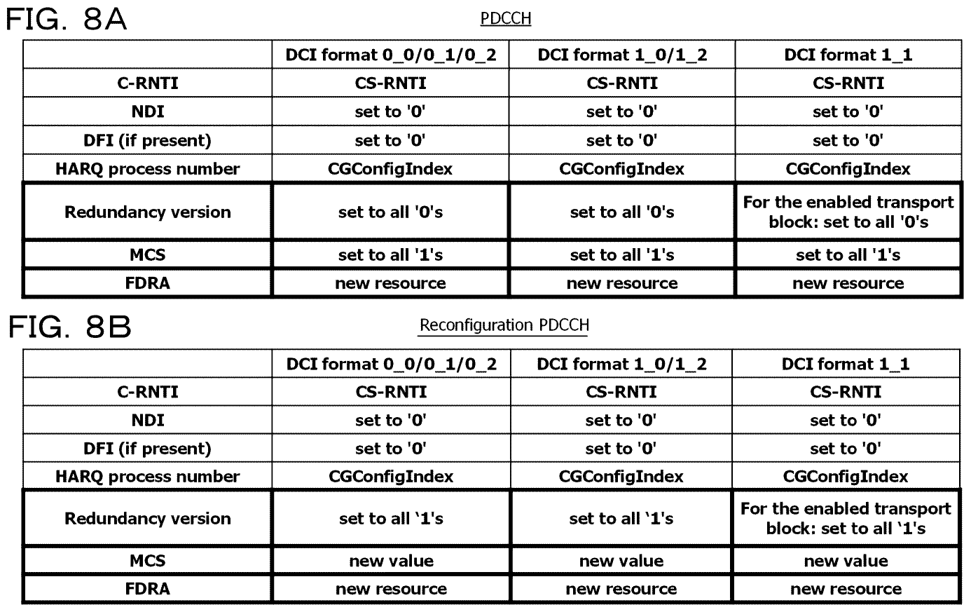

FIGS. 8A and 8B are tables illustrating examples of PDCCHs in the case of a multiple configuration. FIG. 8A illustrates a regular PDCCH, and FIG. 8B illustrates a reconfiguration PDCCH.

In the reconfiguration PDCCH, all “1”s is configured in the redundancy version. There is no problem with inversion, as in the above example.

In the reconfiguration PDCCH, a new MCS value is configured in the MCS.

In the reconfiguration PDCCH, the frequency of the CG resource to be changed is configured in the FDRA. The terminal device 100 changes the frequency of the subsequent CG resources to the frequency configured in the FDRA.

### <Use Cases of Reconfiguration PDCCHs>

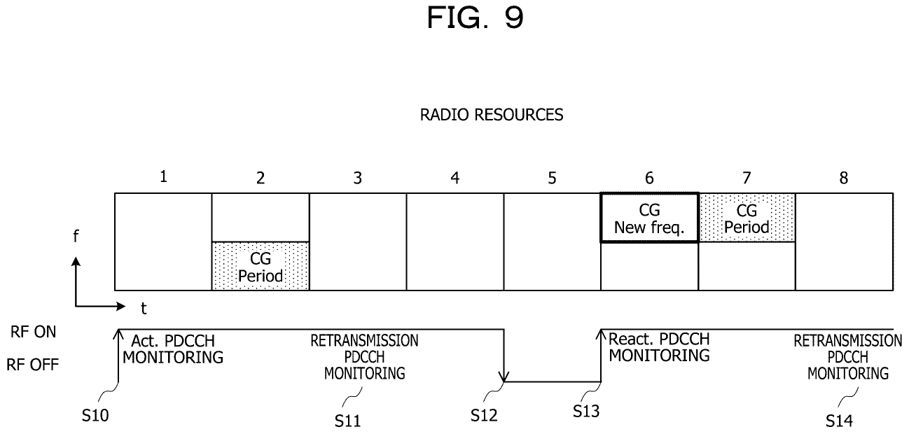

FIG. 9 is a diagram illustrating an example of the radio resources in a use case 1. The use case 1 is a case where transmission of a CG resource is started in slot 2, and a five-slot transmission cycle is maintained. “RF ON” and “RF OFF” in a lower portion of the drawing indicate ON and OFF of the RF unit of the terminal device 100. Also, in the radio resources, the vertical direction indicates frequency (f), and the horizontal direction indicates time (t). Further, the K2 value in FIGS. 1A and 1B is 1. The K2 value indicates the slot length since when a PDCCH was received till a start of the transmission cycle is applied.

The terminal device 100 receives an activation PDCCH in slot 1 (S10). The terminal device 100 starts transmission of a CG resource from the slot (K2=1) next to the slot in which the activation PDCCH has been received.

Since there is a possibility of retransmission of the CG resource, the terminal device 100 monitors a retransmission PDCCH for a predetermined period (S11).

The terminal device 100 then turns off the RF unit in slot 5 after performing the monitoring for the predetermined period (S12).

The terminal device 100 then turns on the RF unit from slot 6 before transmitting a CG resource (slot 7), starts reactivation PDCCH monitoring, and receives a reactivation PDCCH (S13). The reactivation PDCCH includes information about the frequency to be changed.

The terminal device 100 uses the CG resource of the changed frequency (slot 7), and monitors a retransmission PDCCH for a predetermined period (S14).

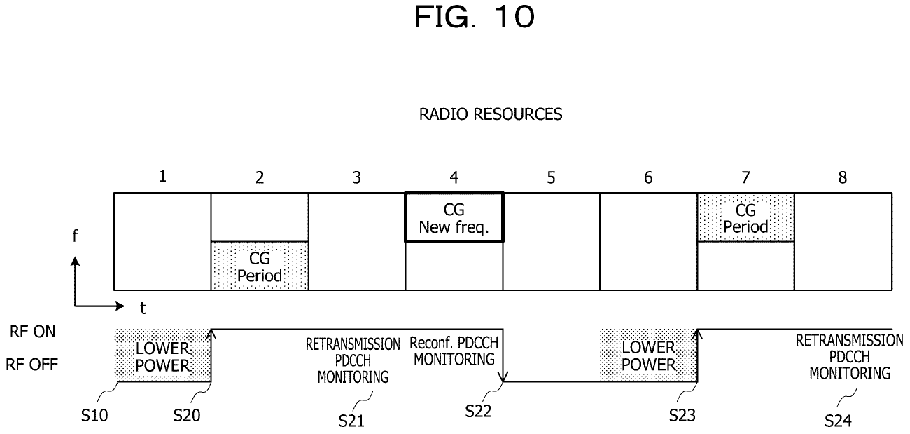

FIG. 10 is a diagram illustrating an example of the radio resources in the use case 1. In FIG. 10, the frequency of a CG resource is changed with the use of a reconfiguration PDCCH.

The terminal device 100 turns on the RF unit in slot 2, and starts transmission of a CG resource (S20). Note that, in FIG. 10, since the terminal device 100 is not based on the assumption that the frequency is to be changed by reception of an activation PDCCH and a reactivation PDCCH, the RF unit can be in an off-state until the timing of transmission of the CG resource.

Since there is a possibility of retransmission of the CG resource, the terminal device 100 monitors a retransmission PDCCH for a predetermined period (S21).

Further, the terminal device 100 monitors a reconfiguration PDCCH. The terminal device 100 then receives a reconfiguration PDCCH in slot 4, and turns off the RF unit (S22).

The terminal device 100 turns on the RF unit in slot 7 (S23), and uses the CG resource of the changed frequency to monitor a retransmission PDCCH for a predetermined period (S24).

As described above, the terminal device 100 does not use reception of a reconfiguration PDCCH as a trigger for changing the CG resource transmission cycle. Thus, the reconfiguration PDCCH can maintain the CG resource transmission cycle while changing the frequency.

Further, the terminal device 100 can realize power saving by receiving the reconfiguration PDCCH during monitoring of the retransmission PDCCH. In FIG. 10, since the RF unit can be turned off in slots 1 and 6, the power consumption of the terminal device 100 is lowered, compared with that in FIG. 9.

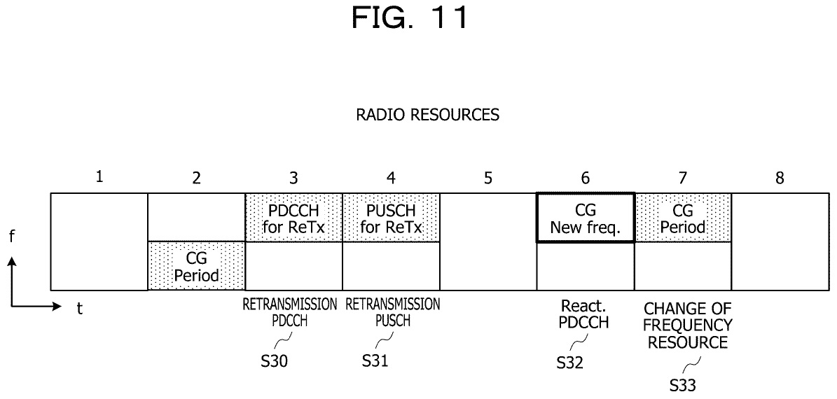

FIG. 11 is a diagram illustrating an example of the radio resources in a use case 2. The use case 2 is an example of a case where a CG resource is transmitted after the frequency of the CG resource is changed when data retransmission occurs. In FIG. 11, the frequency of a CG resource is changed with the use of a reconfiguration PDCCH.

The terminal device 100 transmits data on the CG resource in slot 2. The data transmission on the CG resource then fails, for example, and the terminal device 100 receives a retransmission PDCCH with which retransmission is requested (S30).

The terminal device 100 retransmits data on a resource (a retransmission physical uplink shared channel: PUSCH) whose frequency has been changed from that of the CG resource (S31).

The terminal device 100 receives a reconfiguration PDCCH for changing the frequency of the CG resource to the frequency used for the retransmission (S32).

In the next transmission cycle, the terminal device 100 configures the changed frequency (the frequency used for the retransmission) as the frequency of the CG resource, and transmits data (S33). Thereafter, the CG resource is transmitted at the changed frequency.

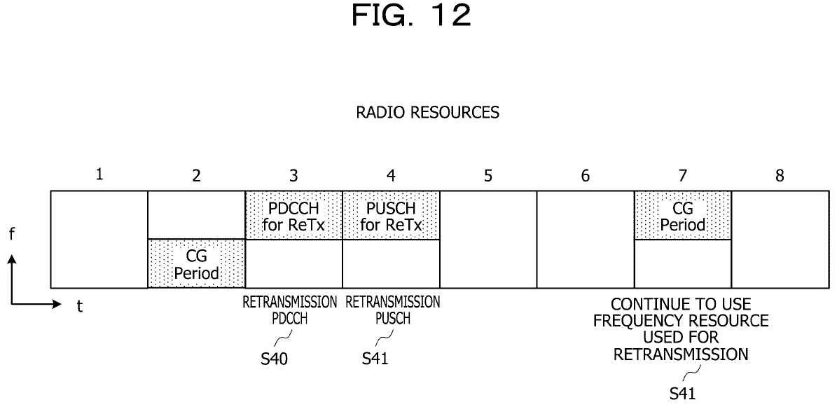

FIG. 12 is a diagram illustrating an example of the radio resources in the use case 2. In FIG. 12, the frequency of a CG resource is not changed with a reconfiguration PDCCH, and the use of the frequency used at the time of retransmission is continued.

The terminal device 100 transmits data on the CG resource in slot 2. The data transmission on the CG resource then fails, for example, and the terminal device 100 receives a retransmission PDCCH with which retransmission is requested (S40).

The terminal device 100 retransmits data, using a resource (a retransmission PUSCH) whose frequency has been changed from that of the CG resource (S41).

In the next transmission cycle, the terminal device 100 configures the frequency used for the retransmission as the frequency of the CG resource, and transmits data (S42). Thereafter, the CG resource is transmitted at the frequency used for the retransmission.

### Other Embodiments

In a case where a frequency resource is changed, an expiration period for the changed frequency resource may be configured. The expiration period indicates how far the changed frequency resource is valid, for example. It may be configured in the changed frequency resource as to whether the frequency resource has been changed only once (the frequency resource prior to the change will be used for the second and subsequent times), for example. Alternatively, it may be configured in the changed frequency resource as to change only N times (N being an integer of 1 or greater), for example. Further, it may be configured in the changed frequency resource as not to have any expiration period, and to continue to be valid thereafter, for example.

The respective requirements described in the first, second, and other embodiments may be combined. Furthermore, the requirements described in the first, second, and other embodiments may be selectively used in accordance with a radio condition, a system requirement, and the like, for example.

Further, the shift amount (width) described in the first, second, and other embodiments may be replaced with a similar concept (time, unit time, timing, or frame, for example), other than the number of slots.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A first wireless communication device that performs pre-allocated communication to communicate with a second wireless communication device, using a radio resource that is configured beforehand, the first wireless communication device comprising:
a controller configured to:
reconfigure a frequency of a pre-allocated radio resource in the second wireless communication device while maintaining a preconfigured transmission cycle of the pre-allocated radio resource, and
control implementation of the pre-allocated communication that uses the reconfigured frequency of the pre-allocated radio resource.

2. The first wireless communication device according to claim 1, wherein,
in the reconfiguring, the controller transmits a reconfiguring control signal that includes the frequency to be reconfigured, to the second wireless communication device.

3. The first wireless communication device according to claim 2, wherein
the reconfiguring control signal is included in a physical downlink control channel (PDCCH).

4. The first wireless communication device according to claim 3, wherein,
in the reconfiguring control signal, a value is configured in a way that the reconfiguring control signal means a reconfiguring control signal in each of values of three predetermined types of fields in the PDCCH.

5. The first wireless communication device according to claim 3, wherein,
in the reconfiguring control signal, a value is configured in a way that the reconfiguring control signal means a reconfiguring control signal in each of values of two predetermined types of fields in the PDCCH.

6. A second wireless communication device that performs pre-allocated communication to communicate with a first wireless communication device, using a radio resource that is configured beforehand, the second wireless communication device comprising:
a second controller configured to:
reconfigure a preconfigured frequency of a pre-allocated radio resource in the first wireless communication device, and
perform the pre-allocated communication that uses the pre-allocated radio resource of the reconfigured frequency while maintaining a transmission cycle of the pre-allocated radio resource.
